(19) United States
(12) Patent Application Publication
(10) Pub. No.: US 2018/0027791 A1
(43) Pub. Date: Feb. 1, 2018

(54) Live Well Buddy

(71) Applicants: JESSE MOREHEAD, DANVILLE, AL (US); JOHN WYDNER, DANVILLE, AL (US)

(72) Inventors: JESSE MOREHEAD, DANVILLE, AL (US); JOHN WYDNER, DANVILLE, AL (US)

(21) Appl. No.: 15/664,836

(22) Filed: Jul. 31, 2017

Related U.S. Application Data
(60) Provisional application No. 62/368,568, filed on Jul. 29, 2016.

(51) Int. Cl. A01K 97/05

(52) U.S. Cl. CPC A01K 97/05

(57) ABSTRACT

A live well buddy is used to contain fish or other catch in a fishing boat's live well, keeping the catch safe and fresh and allowing the user to remove the entire catch at once. A net is perimetrically connected to a flotation ring, forming a live well chamber within the net. Fish are placed within the net through the flotation ring, the user may remove the entire catch by grasping and pulling the flotation ring and attached net out of the live well along with all the fish contained therein. A plurality of weights may be connected to the bottom of the net to keep the bottom portion of the net sunk to the floor of the live well. A stretch-on cover with a slit may be attached atop the flotation ring, providing a cover for the live well chamber while allowing fish to be placed into the live well chamber.

The current application claims a priority to the U.S. Provisional Patent application Ser. No. 62/368,568 filed on Jul. 29, 2016. The current application is filed on Jul. 31, 2017, whereas Jul. 29, 2017 and Jul. 30, 2017 were on a weekend.

### FIELD OF THE INVENTION

The present invention relates generally to fishing. More particularly, the present invention relates to live well storage of a fishing catch.

### BACKGROUND OF THE INVENTION

Fishing is the activity of attempting to catch fish, normally in the wild on rivers, lakes and oceans. Many techniques for catching fish exist, including rod fishing, hand gathering, spearing, netting, angling and trapping. Fishing may include catching aquatic animals other than fish, such as mollusks, cephalopods, crustaceans, and echinoderms. The term is not normally applied to catching farmed fish, or to aquatic mammals, such as whales where the term whaling is more appropriate.

Many fishing boats have a tank called a livewell that is used to keep bait and caught fish alive and healthy before being transferred to land for processing. It works by pumping fresh water from the surrounding body into the tank, as well as keeping the water aerated. Live wells serve an important purpose in keeping a catch fresh and safe. When fishing in a boat with one or more live wells, when removing the catch from a live well the fisherman must bend over and grab the fish one by one to remove them from the well. On days with an especially large catch, it may take a long time to remove all the fish from the live well. Additionally, removing fish by hand adds the risk of being pierced or scraped by the fish's fins. The present invention seeks to address these problems.

### BRIEF DESCRIPTION OF THE DRAWINGS

FIG. 1 is a side view of the present invention.

FIG. 2 is a side view of the present invention placed into a live well containing no water.

FIG. 3 is a side view of the present invention within a live well filled with water and fish.

FIG. 4 is an illustration of removing the present invention from a live well.

FIG. 5 is a top view of the present invention within a live well illustrating the stretch-on cover.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention.

The present invention is an accessory for use in a live well on a fishing boat. The present invention aids in keeping the catch fresh and safe, and aids in removal of the catch from the live well.

As a summary, the present invention starts with a round floating tube that can be bent and folded by hand and released to return to its original shape. Connected to this floatable ring is a net with holes or any shape that sinks into the live well. When the net descends to the bottom of the live well, it expands to cover the entire live well. One net design includes weights at the bottom of the net so the net stays down in the live well. Large holes and tangle free rubber netting keeps the fish from tangling their gills, which allows them to swim freely. This helps keep the stress level of the fish down, which allows them to live longer. The ring is designed to be larger than the entrance to the live well. Thus, the ring must be able to collapse in all directions, return to its original shape quickly, and be capable of this process being repeated many times. The present invention has an optional stretch-on cover made of flexible material with a slit in the center. When a fish is placed atop the cover, the slit opens up due to the weight of the fish and the fish falls through the slit into the live well. The slit then closes back to its original position. When the user has finished fishing and desires to remove the catch from the live well, the user may remove the entire catch from the live well by removing the present invention with all the caught fish retained within the net.

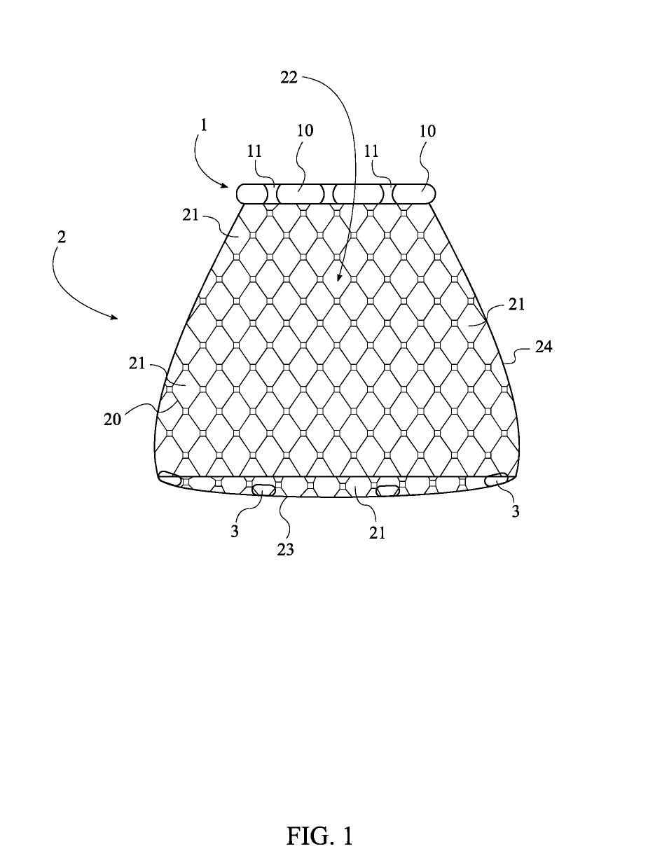

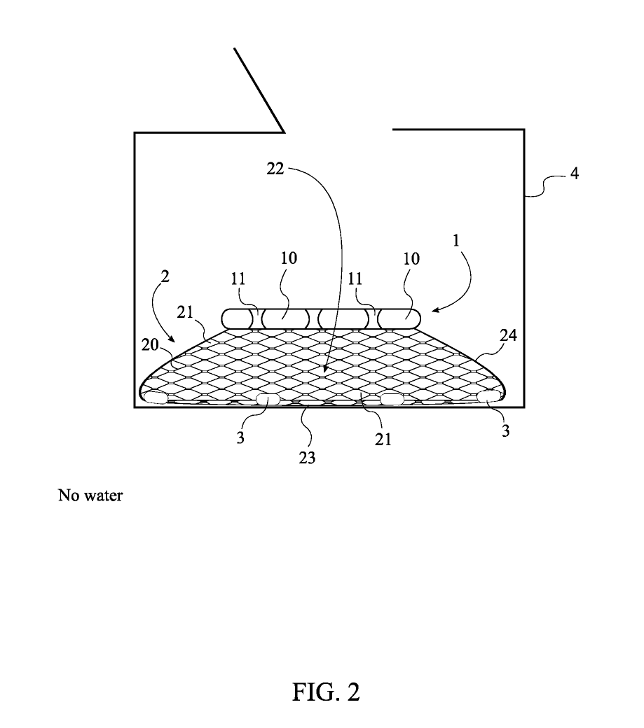

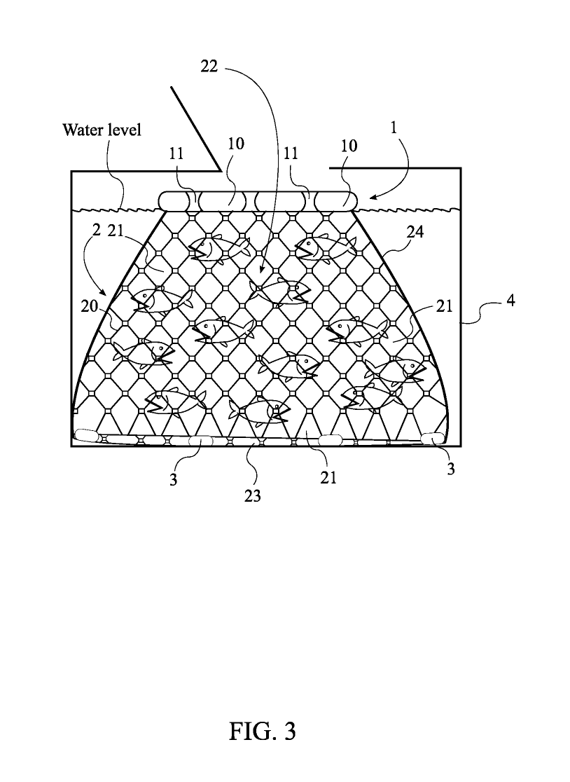

Referring to FIGS. 1-3, in general, the present invention comprises a flotation ring 1 and a net 2. In some embodiments, the present invention may further comprise a plurality of weights 3. The net 2 comprises a net body 20 and a plurality of holes 21. The net 2 is perimetrically attached to the flotation ring 1, such that a live well chamber 22 is formed within the net body 20. In some embodiments, the net 2 is permanently connected to the flotation ring 1. In some embodiments, the net 2 is removably attached to the flotation ring 1. In some embodiments, the net is removably attached to the flotation ring 1 through at least one fastener such as, but not limited to, button snaps, clips, or another fastening means. In some embodiments, end portions of the net are threaded through holes extending through the flotation ring and tied off or glued. The plurality of holes 21 traverse through the net body 20 and into the live well chamber 22. The plurality of holes 21 is distributed around the net body 20, allowing sufficient free flow of water through the net body 20 while trapping the fish within the live well chamber 22 of the net 2. In some embodiments, the plurality of weights 3 may be connected to the net body 20 opposite the flotation ring 1, so that the net 2 stays down within the live well 4. In some embodiments, the plurality of weights 3 is not comprised; rather, the net 3 is designed such that a bottom portion of the net 3 opposite the flotation ring 1 is sufficiently heavy to make sure that the net 2 sinks to the bottom of the live well 4.

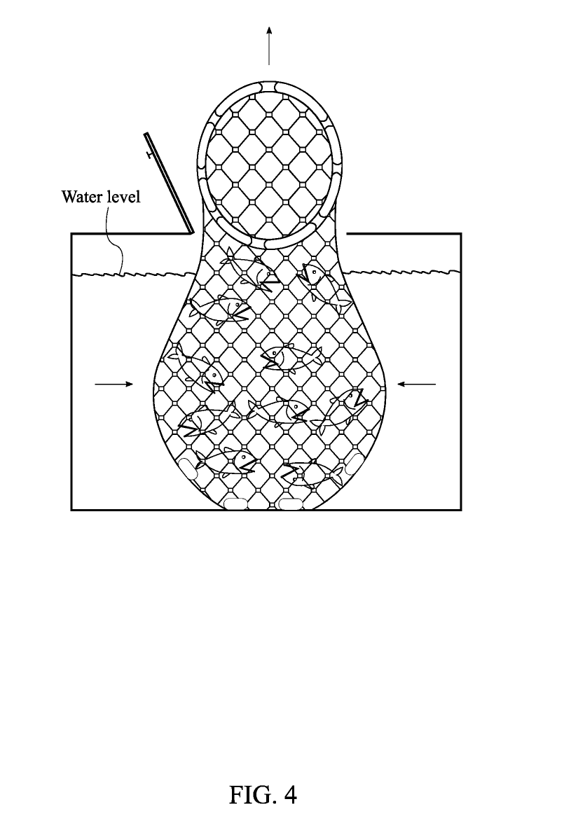

In the preferred embodiment of the present invention, the flotation ring 1 is collapsible and made of a buoyant material. In some embodiments, the flotation ring 1 is made of flexible material. In some embodiments, the flotation ring 1 may comprise a plurality of flotation sections 10 and a plurality of intermediate sections 11. The plurality of flotation sections 10 and the plurality of intermediate sections 11 may be serially and alternatingly connected to each other in order to form the flotation ring 1. This arrangement may aid in the collapsibility attribute of the flotation ring 1. In some embodiments, the flotation ring 1 may have a rounded shape. For example, the flotation ring 1 may be circular in shape. In some embodiments, the flotation ring 1 may have other shapes, such as, but not limited to, ovular, triangular, rectangular, or hexagonal. The flotation ring 1 should be configured to have a larger diameter or total perimetrical dimensions than typical entrances to live wells. This is to ensure fish placed into the live well 4 enter through the flotation ring 1 into the live well chamber 22, instead of falling into the live well 4 outside the present invention. For this reason, the flotation ring 1 needs to be flexible to be able to fit through the entrance to a live well 4. Furthermore, to retrieve the catch within the present invention from within the live well 4, the flexibility of the flotation ring 1 allows the user to remove the catch with one hand or in one motion. When the user pulls upwards on the flotation ring 1 to remove the present invention from the live well 4, the flotation ring 1 and therefore the net 2 as well begin collapsing to the center, allowing the catch to be removed from the live well 4 with ease. This is illustrated in FIG. 4.

In the preferred embodiment, the net 2 is a tangle-free rubber net 2. The net 2 should be configured in a manner that facilitates free flow of water within the live well chamber 22, while preventing the fish from escaping the live well chamber 22. It is contemplated that many variations of geometrical configurations may be comprised by the net 2 to accomplish this purpose. Furthermore, it is contemplated that the material of the net 2 should not be restricted to rubber, and the net 2 may be made of any desirable and useful material. The net 2 may be manufactured as a plurality of interwoven material strands such as rope, or the net 2 may be created by any cutting process through cutting holes in a solid sheet of material to create the net 2. The net 2 should be ideally configured with large holes and tangle-free rubber to keep the fish from tangling their gills in the net 2 and allowing them to swim freely within the live well chamber 22. In the preferred embodiment, the rubber creates a buffer between the fish and the hard interior surface of the live well 4, protecting the fish from stress, thus allowing the fish to live longer and maintain their weight.

In some embodiments, each of the plurality of weights 3 is positioned within the net 2. In some embodiments, the plurality of weights 3 is connected exterior to the net 2 opposite the live well chamber 22.

In some embodiments, the net body 20 may comprise a bottom portion 23 and a lateral portion 24, with the lateral portion 24 being connected between the bottom portion 23 and the flotation ring 1. In some embodiments, the plurality of weights 3 is connected to the bottom portion 23 of the net body 20.

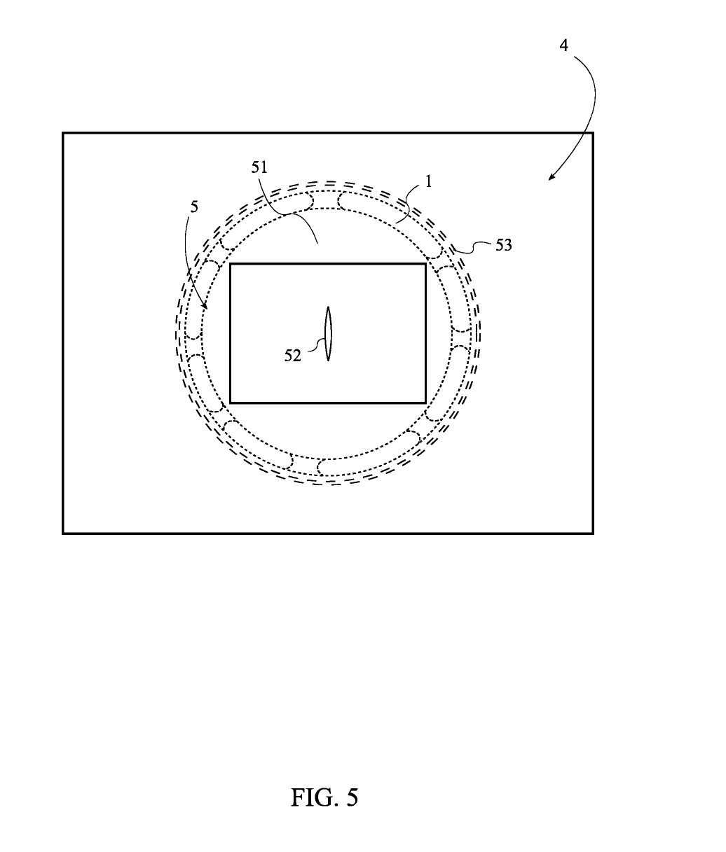

Referring to FIG. 5, in some embodiments, the present invention may further comprise a stretch-on cover 5. The stretch-on cover 5 and the flotation ring 1 are illustrated in FIG. 5 by dashed lines behind the ceiling of the live well 4. The stretch-on cover 5 may be removably and perimetrically attached around the flotation ring 1 opposite the net 2, forming a cover over the live well chamber 22. The stretch-on cover 5 may comprise a cover body 51 and a slit 52. The slit 52 is preferably centrally positioned on the cover body 51 over the flotation ring 1. The slit 52 traverses through the cover body 51, allowing access through the cover body 51 into the live well chamber 22. Furthermore, the stretch-on cover 5 should be made of elastic material, allowing the slit 52 to open to allow a fish to pass through the stretch-on cover 5, and return to its original generally closed position upon removal of the weight of the fish from atop the cover body 51. The stretch-on cover 5 may furthermore comprise an elastic band 53 perimetrically connected around the cover body 51, such that the stretch-on cover 5 may be placed over the flotation ring 1 by physically stretching the elastic band 53 and the cover body 51 to exceed the dimensions of the flotation ring 1, placing the elastic band 53 around the flotation ring 1, and releasing tension on the elastic band 53 to secure the stretch-on cover 5 in place over the flotation ring 1.

Although the invention has been explained in relation to its preferred embodiment, it is to be understood that many other possible modifications and variations can be made without departing from the spirit and scope of the invention as hereinafter claimed.

What is claimed is:

1. A live well buddy comprises:
a floatation ring;
a net;
the net comprises a net body and a plurality of holes;
the net being perimetrically attached to the flotation ring, wherein a live well chamber is formed within the net body;
the plurality of holes traversing through the net body into the live well chamber; and
the plurality of holes being distributed around the net body.

2. The live well buddy as claimed in claim 1 comprises:
the net being removably attached to the flotation ring.

3. The live well buddy as claimed in claim 1 comprises:
the net being permanently connected to the flotation ring.

4. The live well buddy as claimed in claim 1 comprises:
a stretch-on cover;
the stretch-on cover being removably and perimetrically attached around the flotation ring opposite the net;
the stretch-on cover comprises a cover body and a slit;
the slit being centrally positioned on the cover body over the flotation ring; and
the slit traversing through the cover body.

5. The live well buddy as claimed in claim 1 comprises:
the flotation ring comprises a plurality of flotation sections and a plurality of intermediate sections; and
the plurality of flotation sections and the plurality of intermediate sections being serially and alternatingly connected to each other.

6. The live well buddy as claimed in claim 1 comprises:
the flotation ring being collapsible.

7. The live well buddy as claimed in claim 1 comprises:
the flotation ring being made of a flexible material.

8. The live well buddy as claimed in claim 1 comprises:
the flotation ring being made of a buoyant material.

9. The live well buddy as claimed in claim 1 comprises:
the flotation ring having a rounded shape.

10. The live well buddy as claimed in claim 1 comprises:
the flotation ring being circular in shape.

11. The live well buddy as claimed in claim 1 comprises:
a plurality of weights;
the plurality of weights being connected to the net body opposite the flotation ring; and
the plurality of weights being positioned within the net.

12. The live well buddy as claimed in claim 1 comprises:
the net body comprises a bottom portion and a lateral portion; and
the lateral portion being connected between the bottom portion and the flotation ring.

13. The live well buddy as claimed in claim 12 comprises:
a plurality of weights being connected to the bottom portion.

14. The live well buddy as claimed in claim 1 comprises:
the net being a tangle-free rubber net.
